(19) United States
(12) Patent Application Publication
(10) Pub. No.: US 2016/0078407 A1
(43) Pub. Date: Mar. 17, 2016

(54) Affiliated business method

(71) Applicant: Bijan Dokhanian, Beverly Hills, CA (US)

(72) Inventors: Bijan Dokhanian, Beverly Hills, CA (US); Zoltan Kemeny, Chandler, AZ (US)

(21) Appl. No.: 14/756,814

(22) Filed: Oct. 16, 2015

(51) Int. Cl. G06Q 10/10

(52) U.S. Cl. CPC G06Q 10/1057; G06Q 10/103

(57) ABSTRACT

Disclosed is a business method of an Organizer (1^{st} Co.) and at least one, but rather a multiplicity of Affiliates (2^{nd} Co.) conducting business under contract to produce in the USA manufactured products at US wage rates, which however costs only as much to Affiliates as much wages paid in China or other similar countries, yet the products would sell in the USA and its affiliated exemplary territories at fair US market price. The savings in overseas shipping is subsidizing wages and broken down to 3 territories of the USA with some of its neighbors. Affiliates pay membership fee for participating in the program, in which Organizer exclusively manages Affiliates' payroll, freight forwarding and tradeshows. Exporting fee structure assures no reimporting to the USA at profits. Affiliates provide health insurance, near factory housing, 3× hot meals 365 days a year, work place exercise means, and security at work and housing.

### FIELD OF THE INVENTION

This invention relates to subsidized wages of USA manufacturing affiliates with housing and meal provisions to life insured workers.

### BACKGROUND OF THE INVENTION

The invention fulfills the need for reducing or eliminating labor cost of US factory workers to make and sell manufactured products domestically at competitive price same-or-similar to Chinese products, thereby contributing to normalizing trade balances and create well paid manufacturing factory jobs secured by privately funded social benefits, which includes quality housing, security, recreation facility, daily meals and life insurance, whereas the affiliated manufacturers participating in the labor subsidizing program pay $3/hr for labor, get $12/hr subsidy from affiliate program, while the workers get paid $15/hr, plus benefits and services at low cost to them.

Manufactured products imported from China are impacted by 15% to 20% shipping cost and Import Duties at the West or East Coast of the USA respectively and 17-18% at the South Coast. Once the product is manufactured in the USA, that cost can be saved and used to subsidize labor cost.

It is customary in China to build factories with basketball court, housing units to the workers and to provide daily meals to them at no cost 7 days a week. That is one reason that they work for $3/hr in manufacturing. They don't need daily commute transportation. The housing units are near to the factory and security is provided at work and at housing at all times.

The labor rate in the USA is 5× more, but the expenses of the workers are proportionately higher as well since their health care and living expenses are higher as well.

If the 4× difference can be made up profitably by import savings and other practical means, the labor would not cost more in the USA than it does in China, manufacturing jobs would return, trade balance would normalize, and self-reliance would ensure economic stability and national security in case the country would be attacked.

The main object of this invention is remedy the stated situation by innovative business method affiliating manufacturers, who participate in a program, which aims to balance the above stated disequilibrium.

Another object is to standardize and modularize the affiliation to syndication of affiliate business units employing 50 laborers per every $10-million generated in annual sales, whereas the construction and setup cost would average $2.5 million. Such module is however only a standard unit for accounting and impose no limitation on the actual size of a manufacturing factory and its facilities.

Yet another one is to invite worldwide investment to build such factories and surrounding housing units, which would attract other services next to the housing area.

Also, to use the government EB-5 or other investor programs to facilitate foreign or alien labor participation to supply laborers for jobs not particularly favored by domestic work force.

Also, to incentivize production of affiliates and workers by various means, including life insurance premium loaned to the workers as 50% beneficiary and pay raises per higher productivity measured by sales, whereas the workers can insure themselves and their family members and need not pay back the loan until one of the insured passes away, when the loan is to be paid back with 50% of the benefits received.

Also to ensure mutually beneficial incentive and fee system between organizer of such program and its affiliated program participants, who may go public and assign 5% equity or stocks to the organizer.

Also, to, manage freight forwarding of affiliate's products by the organizer to ensure sales at fair market price and manage exports.

And finally, to manage annual tradeshows for the program participants by the organizer to promote the products of the participants.

### SUMMARY OF THE INVENTION

The above problems and others are at least partially solved and the above objects and others realized in a process, which according to the teachings of this invention, uses an affiliated business method comprising at least the following steps, terms and conditions:
1. Organizer sets up affiliate Program for Affiliates within a dedicated cooperative Association;
2. Affiliates join the Association and pay the $ 10,000/yr/Module association Fee to Organizer for participation in the affiliate Program and to enjoy the benefits of assured quality labor at fractional cost;
3. Organizer accounts Affiliates in Modules of 50 workers paid at $15/hr by Affiliates to produce and sell product of $10,000,000/yr without limiting actual Factory sizes of and wages paid by Organizers, whereas proportionally less but higher paid workers or more but lower paid workers may be included in a Module, for instance 25 workers paid at $30/hr rate or 100 workers paid at $7.50/hr rate;
4. Affiliates establish Factories with Housings for Workers and provide all-day Meals on every working and resting days, for instance 3× a day hot meals 7 days a week, workers exercise facility, including a basketball court, and security at work and around the housing area;
5. The cost of the Housing and Meals are 100% born by the Affiliates;
6. Deducted from paychecks, Workers pay none for the Meals and $250/week for the Housing to the Organizer who shares it with Affiliate 50/50%;
7. Affiliates pay 100% for the Worker's Health insurance;
8. Workers obtain Life insurance with premiums loaned by Organization as 50% beneficiary of the policy, while the payments are processed by Organizer and the loan is due for back payment in full with 50% of the benefits only upon the passing away of one of the beneficiary, yet offering such help and accepting it is not mandatory but optional;
9. Affiliate manufacturing Modules of 50 Workers paid at $15/hr or equivalent Modules produce Products and sell those in an amount equal or higher than $10,000,000 annually at fair USA market price;
10. Organizer pays $15/hr to the Workers for work done at the same going rate in the same industry;
11. Affiliate pays $3/hr wage subsidy to the Organizer per $15/hr paid to workers,
12. Affiliates on the Western USA triangle W pay 15% on product sales price to Organizer, on the Eastern USA triangle E 20% and on the Southern USA triangle S 17.5% for the Program use, turning over the otherwise due overseas shipping and import duty expenses saved to the Organizer and get paid by the customer in the same amount additional to the cost of manufacturing, while Organizer as freight forwarder ships Affiliate's Products to their customers or distributors, thereby controlling the sales information;
13. Organizer manages special tradeshows for Affiliates where Affiliates pay preferential price to Organizer for demo spaces and events with no mandatory participation;
14. Affiliates assign 5% of outstanding stocks or equity to Organizer if or when go public;
15. Affiliates pay 3% fee for freight forwarding services to Organizer on exported Products;
16. Organizer offers the following productivity incentives to Affiliates;
   (a) $0.5/hr extra for sales of $10,000,000/yr if it produced by 40 Workers or less paid at $ 15/rh rate, and
   (b) $0.5/hr extra for sales of $12,000,000/yr or more if it produced by 50 Workers paid at $ 15/hr rate;
      where the Organizer exclusively manages The Affiliates' payroll, freight forwarding and tradeshow organizing.

Managing the payroll ensures the Organizer to control wages. Managing the freight forwarding ensures the Organizer control over domestic and export product distribution and prices. Managing the tradeshows ensures the Organizer of revenue continuity through Product promotion.

The combined effect of the terms and conditions with the incentives may result net zero labor cost to the affiliates, transferring their factory to an income property.

Wages, prices and incomes are in USD₂₀₁₅ and are only exemplary here. Percentages of incentives and commissions are also exemplary. Also exemplary are the Module sizing and its rules.

Organizer assist Affiliates in acquiring EB-5 investment if needed.

Affiliate either builds the required factory or modify its existing one to comply with the Program requirements herewith.

Organizer can cancel Affiliate membership upon violations of Program rules and conduct requirement, in which case the departing Affiliate cannot duplicate the Program with or without modification alone or in association with others.

### BRIEF DESCRIPTION OF THE DRAWINGS

Referring to the drawings:

FIG. 1 is an operations diagram of a preferred method as per the teachings of the invention.

FIG. 2 is a map of the USA illustrating the E, S and W triangles.

### DETAILED DESCRIPTION OF A PREFERRED EMBODIMENT

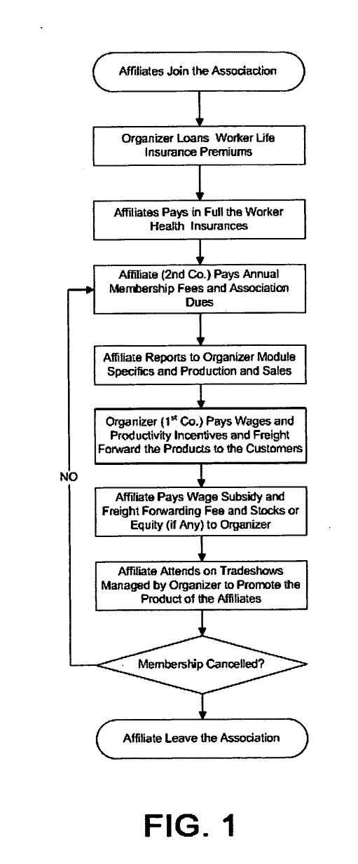

Attention is now turned to FIG. 1, which illustrates an operations diagram of a preferred method as per the teachings of the invention.

The process starts with Affiliates joining the Association organized by the Organizer by signing up and paying setup and membership Fees.

The Affiliates are manufacturing firms predominantly employing wage earners who produce and sell Products and provide quality Housing and Meals to their Workers and pays for their Health insurance. Workers of a Module pay $ 250/week to the Organizer, who share that 50/50% with the Affiliates. The apartment housing is in the factory's vicinity, so Workers need no transportation. The Affiliate employers provide 3× daily hot meal 7 days a week to the employee Workers on site. The cost of these labor benefits are shared 50/50% by the Affiliates and the Organization. The Affiliates pay $3 wage subsidy to the Organizer. Affiliates provide security at workplace and housing area.

The Organizer is a registered company who pays the Affiliate's Worker wages, loans the premiums of the Worker's life Insurances as 50% beneficiary of the policies and conducts financial transactions with the Affiliates which relates to the Affiliate's production, sales and promotion activities. Organizer manages Affiliate's payroll, freight forward its Products and organizes annual tradeshows for Affiliates to showcase their Products.

The Affiliates pay $10,000/yr/Module membership fee to the Organizer to participate in the private labor subsidizing Program. Said Module is an accounting unit of 50 Workers paid at $15/hr rate producing $10,000,000 Products sold. A participating factory may have any number of Workers at any wage rate at any value of sold Products. The modules are flexible. For instance, a Module can have 25 Workers paid at $30/hr rate and produce $10,000,000/yr. 10 Workers paid at $75/hr producing $10,000,000/yr also makes up a Module. Where lower than $15/hr wage is legal to pay, 100 Workers paid at $7.50/hr rate producing $ 10,000,000 also qualifies for a Module. These numbers are exemplary however.

Next, the Organizer offer loans and, if accepted, manages the premium payments of the life Insurance of the Workers on them and on their chosen family member's life, pays all the premiums thereof while the Workers name the Organizer as 50% beneficiary of the policy. The loan is only due for payback upon the passing away of one of the insured, when Organizer receives 50% benefits of the policy.

Next, the Affiliates pay for 100% of the Worker's Health insurance.

Now, the affiliates pay membership Fees which due annually. Then Affiliates report to Organizer the actual number of Modules, their production and sales. Organizer uses these numbers for its accounting to provide proper payroll management service to Affiliates.

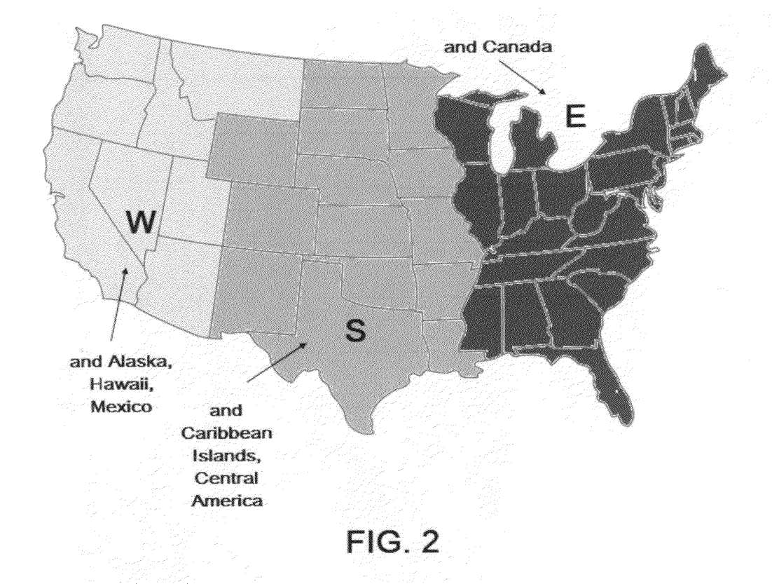

Now, Organizer pays wages as per the established Module specifics, and, as freight forwarder, ships Affiliate's products to its customers. Affiliate, from the sales price paid, pays to Organizer an equal amount as much it would cost to import the Products from Far-East or Europe overseas. That, as a freight forward fee, would be in the Western USA triangle W 15%, on the Eastern USA triangle E 20% and on the Southern USA triangle S 17.5%, as shown in FIG. 2. That is the price of participation in the Program, in which the Affiliates only pay $3/hr wages for Products sold in the USA at fair market price.

Then, Affiliate pays $3 wage subsidy to Organizer and the 15-20% freight forwarding fee depending on the 3 triangular territories (W, S and E).

At times, at least annually, affiliate may participate in tradeshows managed by Organizer to facilitate the promotion of Affiliate's Products.

For violating terms and conditions or Program rules, Affiliates' membership may be terminated by the Organizer. In that case, the Affiliate leaves the Association being barred from duplicating the Program. Unless terminated, Affiliate keeps participating and repeat the steps from paying the annual membership dues.

Attention is finally turned to FIG. 2, which illustrates the 3 triangle zones, W, S and E, of the USA, in which the 15%, 17.5% and 20% freight forwarding fees applies respectively. Alaska, Hawaii and Mexico are included in triangle W, while the Caribbean Islands and Central America are included in triangle S, and Canada is included in triangle E. These territories are exemplary however.

The present invention is described above with reference to a preferred embodiment. However, those skilled in the art will recognize that changes and modifications may be made in the described embodiment without departing from the nature and scope of the present invention. For instance, the proposed method may be employed in Canada and other developed countries with or without obvious modifications.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Business method comprising 1^{st} and 2^{nd} Companies in contractual bound to follow steps as specified in FIG. 1 and share responsibilities and tasks as follows:
a) 1^{st} Co. exclusively manages the payroll, the freight forward, and the tradeshows of 2^{nd} Co.
b) 2^{nd} Co. pays fractional wage subsidy to 1^{st} Co. amounting to about 20% wages of 2^{nd} Co. workers
c) 1^{st} Co. pays the wages of the workers of 2^{nd} Co.
d) 1^{st} Co., loans the workers of 2^{nd} Co. life insurance premium payments for 50% beneficiary payment upon the passing away of one of the insured when the loan is to be paid back and 50% of benefits of the policy
e) 1^{st} Co. pays contingent productivity incentives to 2^{nd} Co. upon meeting agreed upon requirements
f) 2^{nd} Co. provides 3× hot meals a day year around, 7 days a week, physical exercise means and place to workers at workplace, nearby housing to workers, health insurance, and security at work and at said housing
g) 2^{nd} Co. grants near to 5% stocks to 1^{st} Co. upon 2^{nd} Co. going public
h) 2^{nd} Co. pays to 1^{st} Co. near 3% freight forwarding fee on exported products of 2^{nd} Co. on products exported to countries other than the ones are specified in FIG. 2
i) 2^{nd} Co. pays to 1^{st} Co. freight forwarding fee on products made by 2^{nd} Co. per triangular territories defined in FIG. 2 as follows: near 15% in triangle W, including Alaska, Hawaii and Mexico nearly 17.5% in triangle S, including the Caribbean Islands, and central America, and nearly 20% in triangle E, including Canada
j) 1^{st} Co. accounts the labor and production of 2^{nd} Co. in accounting Modules equivalent of 50 workers paid at about $15 USD₂₀₁₅/hr wage rate producing product sold in said triangles for about $10,000,000 USD₂₀₁₅ and ties incentives for 2^{nd} Co. based on said Modules, where said wage rate can be any reasonable fraction or multiple of said value
k) 1^{st} Co. organizes tradeshows for 2^{nd} Co. at least once a year without mandatory participation od 2^{nd} Co. where 2^{nd} Co. promotes its products
l) 1ₛₜ Co. pays to 2^{nd} Co. said incentives not to exceed 5% of said wage rate per said Modules
m) Workers of 2^{nd} Co. pay about $250USD₂₀₁₅/week to 1^{st} Co. for housing, who shares that with 2^{nd} Co. equally
n) 1^{st} Co. loans to workers of 2^{nd} Co. for their life insurance premiums for being named as 50% beneficiary of the policy, while the loan is only due for back payment upon passing away of one of the insured, when the 50% benefit is also due, while there is no obligation from either party to enter into contract controlling such assistance by loaning
o) 2^{nd} Co. pays to 1^{st} Co. annual membership fee as long as its membership is maintained by 1^{st} Co., whereas said membership entitles 2^{nd} Co. to the benefits listed here a) through o), while 1^{st} Co. maintains said membership as longs as said fees paid and rules, regulations, terms and conditions are set a) through o) are not violated by 2^{nd} Co.

2. Business method as per claim 1, whereas 2^{nd} Co. build new factory to comply with said rules and regulations.

3. Business method as per claim 1, whereas 2^{nd} Co. modifies existing factory to comply with said rules and regulations.

4. Business method as per claim 1, whereas 1^{st} Co. requires 2^{nd} Co. to mark its product as “Made in USA” for both domestic market and export.

5. Business method as per claim 1, with a multiplicity of said 2^{nd} Co.

6. Business method as per claim 1, with 2^{nd} Co. as EB-5 participant.
